(19) United States
(12) Patent Application Publication
(10) Pub. No.: US 2016/0308950 A1
(43) Pub. Date: Oct. 20, 2016

(54) SYSTEM AND METHOD FOR CREATING AND TRANSFERRING MEDIA FILES

(71) Applicant: BUSINESS MOBILE SOLUTIONS INC., Saint-Jerome (CA)

(72) Inventors: Thomas Bouvrette, Mirabel (CA); David Richard, St-Sauveur (CA)

(21) Appl. No.: 15/101,493

(22) PCT Filed: Dec. 8, 2014
(86) PCT No.: PCT/CA2014/051180

§ 371 Date: Jun. 3, 2016

Related U.S. Application Data
(60) Provisional application No. 61/913,573, filed on Dec. 9, 2013.

(51) Int. Cl. H04L 29/08; G06F 17/30

(52) U.S. Cl. CPC H04L 67/06; G06F 17/3002; G06F 17/30123; G06F 17/30091; G06F 17/30203

(57) ABSTRACT

A system and method for creating and transferring media files is provided. The system and method allow for the transfer of files to a specific location on remote storage without having to first create the specific location on the remote storage system. The method comprises the steps of: receiving an input corresponding to a selected working directory; capturing at least one media file with a processor-based device; automatically renaming the media file to include an indicia corresponding to the selected working directory; receiving a transfer command; transferring the media file to remote storage, and instructing the remote storage to create a storage folder based on the indicia, and to store the media file in the storage folder. The system comprises at least one processor-based device comprising memory, a processor, input means, capturing means, a renaming module, a communications unit and a file transfer module.

### RELATED APPLICATIONS

This application claims priority to PCT Int'l. App. No. PCT/CA2014/051180, filed 08 Dec. 2014, which claims priority to U.S. Provisional Patent Application No. 61/913,573, filed 09 Dec. 2013. Each of these priority applications is expressly incorporated by reference herein in its entirety.

### FIELD OF THE INVENTION

The invention relates to the field of electronic devices and computer science. The invention more particularly concerns a system and a method for naming, managing and transferring media files.

### BACKGROUND OF THE INVENTION

Most auto body mechanics have to send justification documents to the insurer for an evaluation as to the integrity of the damaged car. With the help of these documents, the insurer replies to the auto body mechanics regarding the work to be done on the vehicle. Normally, the justification documents include pictures taken with a digital camera. The auto body mechanics send the pictures to the insurer via the internet. In order to accomplish this operation, an employee of the auto body shop has to transfer the files from the digital camera onto a computer and then needs to select the photos within an unmanaged data memory where other files could also be stored. Then, he has to regroup the pictures, classify them and transfer them to the insurer.

It is also common for employees to include written notes along with the pictures. In the case where documents other than images need to be transferred, such as written documents, the employee needs to locate them since they are not saved on the same device as the one on which the pictures were taken. The employee then needs to join the written notes manually in the client's folder. In some cases, more than one person may have worked on the same car accident case, and therefore files associated with the same case are saved on two different devices. This situation doubles the task of classifying and managing files related to a case, and increases the risk of mixing or losing information related to a case. Employees also need to wait for their colleagues to complete their portion of the work before being able to work on the case, which further increases time losses.

While the situation described above applies to pictures taken by auto body mechanics, there are many other domains for which the management of media files (such as images, pictures, videos, or audio files) requires the downloading of files from a device to a computer, and then manually renaming, sorting and uploading of the media files from this computer to another remote computer or storage medium.

With the advent of digital cameras and other features onto mobile devices, it is possible to take pictures and to transmit them wirelessly in order to access the files from any location, as long as communication link is accessible. The pictures can be sent via Wi-Fi, cellular networks, Bluetooth, However, while it is possible to transfer and access the image files, the files themselves are still unmanaged. In other words, while wireless ports in digital cameras allow avoiding the manual transfer of the files, the problem of having to rename, sort and/or classify the files remains.

There is thus a need to improve the existing processing device and methods of operating thereof so as to facilitate the management and transfer of files, including not only image files, but also video, audio, text and other digital files from mobile devices to remote storage systems.

### SUMMARY OF THE INVENTION

The present invention provides a system and method for creating and transferring media files from a processor-based device used to a remote storage location.

Broadly described, the method includes steps of transferring media files (such as audio, image, text, portable document format or video files) from a processor-based device, typically a wireless mobile device but using other processor-based devices is possible, to a specific location on a remote storage system (such as a folder and/or subfolder location) without having to first create the specific location at the remote storage system.

It other words, the folder/subfolder directory does not need to be created on the remote storage system before starting the transfer process from the wireless mobile device.

According to an embodiment, the method includes a step of receiving, on a processor-based device, a first user input corresponding to a selected working directory. This step a step can include the selection of a pre-existing default directory or the creation of a new directory on the processor-based device. The selected working directory can thus comprise a pre-existing default or a new directory.

The method also includes a step of capturing one or more media files on the processor-based device. The media file(s) can include at least one of a picture file, a video file, an audio file and a text file. It is also possible that the media files include other types of digital files with a predetermined extension, such as a jpeg or a pdf file. The media files typically include several picture files and at least one audio file or text file. In an optional embodiment of the method, two image files are captured: the first image file is a user image file captured with a front camera of the processor-based device, and the second image file is a location image captured with a rear camera of the processor-based device.

The method also includes a step of automatically renaming each of the media file(s) with a respective file name including indicia corresponding to the selected working directory. In other words, each file captured with the processor-based device is, at least temporarily, renamed with a file name including indicia or indication of the working directory. Typically, the name of the file will include the name of the working directory. It is also possible to include additional indicia in the file name, corresponding to a creation date, a creation time and/or a location. The method can also include capturing the global positioning system (GPS) coordinates of the processor-based device. In this case, the location added in the file name can include the GPS coordinates.

The next step comprises receiving a transfer command on the processor-based device. The transfer command can be a second user input on the processor-based device. Alternatively, the transfer command can be sent by a background process running on the processor-based device. Responsive to the transfer command, the processor-based device establishes a communication link with a remote storage, and transfers the one or more media files to the remote storage, and generates instructions directing the remote storage to create a storage folder based on the indicia in the file name of the media file(s), and to store the media file(s) in the storage folder. Typically, several media files are transferred simultaneously to the remote storage. Advantageously, the media files can be transferred from the processor-based device (mobile phone, digital camera or else) to a remote storage (typically a remote server or cluster of servers) without first needing to create the storage folder(s) at the remote storage. The files to be transferred include, at least partially, the instructions to manage and/or create the storage files. There is thus no need to install special software at the remote storage for the process to work.

Optionally, the method further includes a step of receiving on the processor-based device a confirmation, from the remote storage, that the media file(s) was/were successfully transferred to the storage folder. Still optionally, it is also possible to store the media file(s) on the processor-based device in a location corresponding to the selected working directory. The method can comprise a step of moving or deleting the media files from the location corresponding to the selected working directory on the processor-based device, such as when receiving a confirmation that the transfer has been successfully completed. It is also possible that the communication link with the remote storage is established only when a network connection is available on the processor-based device, such as a LAN, WAN or WWAN.

Optionally, the method can include a step of sending deletion instruction to the remote storage, directing the remote storage to delete duplicate(s) of media file(s) if the media file(s) already exist(s) on the remote storage in the storage folder.

It is also possible for the remote storage to copy the media files to a third device, a computing device, which can be a personal computer, a server or any other similar device. The media files are copied on a local folder having the same name as the one created on the remote storage. This step includes establishing a communication link between the remote storage and the computing device; receiving the media file(s) on the computing device from the remote storage and, in response thereto, creating a local folder on the computing device based on the indicia in the file name of the one or more media file(s); and storing the media file(s) on the computing device in the local folder. The method can thus include a step of synchronizing the local folder of the computing device with the storage folder of the remote storage. Still optionally, it is possible to generate a notification on the computing device when the media file(s) received on the computing device has/have an attribute matching a predetermined criterion, the notification being a user-perceivable notification. For example, when image files relating to a critical case are received on the local computer, an alert can be displayed on the display screen of the local computer.

According to another aspect of the present invention, a system for transferring and storing media files is provided. The system includes at least one processor-based device including: memory and a processor; input means for receiving the first user input corresponding to the selected working directory; capturing means for capturing the media files; a renaming module stored in the memory and comprising renaming instructions executable by the processor for automatically renaming each of the media files with a file name including indicia corresponding to the selected working directory; a communications unit configured to establish a communication link with a remote storage; and a file transfer module stored in the memory and comprising transfer instructions executable by the processor to transfer the one or more media file(s) to the remote storage, directing the remote storage to create a storage folder based on the indicia in the file name of the media file(s), and to store the media file(s) in the storage folder.

Preferably, the processor-based device is a wireless mobile device. The device can include one of an OS-based media camera, a smart phone, a tablet and a laptop. Alternatively, the processor-based device can be a photocopier, a fax or a scanner.

In an embodiment, the system also includes a computing device. The computing device includes: a memory and a processor; a communications unit configured to establish a communication link with the remote storage; and a file receiving module stored in the memory and comprising receiving instructions executable by the processor to receive the media file(s) from the remote storage, create a local folder on the memory based on the indicia in the file name of the media file and save the media file to the local folder. The computing device can be for example a server, a desktop computer or a laptop computer.

The system can also include the remote storage. The remote storage includes a memory and a processor; a communications unit configured to establish the communication link with the processor-based device; and a file storage module stored in its memory and comprising the storage instructions executable by the processor to receive the media file(s), identify the indicia in the file name(s), create the storage folder in the memory corresponding to the indicia, and save the at least one media file to the storage folder.

Finally, according to yet another aspect of the present invention, a computer program product is provided. The computer program product includes: a computer usable medium including computer usable program code for creating and transferring media files, the computer program product including: computer usable program code for receiving the user input corresponding to a selected working directory; computer usable program code for capturing one or more media files(s) and for renaming the media file to include indicia corresponding to the selected working directory; computer usable program code for receiving a transfer command; and computer usable program code for transferring the media file to remote storage, the media file comprising storage instructions directing the remote storage to create a storage folder based on the indicia in the file name of the media file, and to store the media file in the storage folder.

Advantageously, the invention allows one with minimal knowledge of processor-based devices including image capturing means, to take pictures (original or annotated with text, drawings and/or a vocal note), videos, voice, text or scan documents and send them via a Wi-Fi connection, cellular networks, etc. into a specific folder and/or subfolder that is created at the moment of the transfer. The present invention also allows one to conduct several transfers to the same remote storage location at once. The number of simultaneous transfers is determined by the number of network connection that the processor-based wireless device can handle.

An advantage of the proposed invention is that it eliminates waste of time by allowing users to create or select folders and subfolders directly on the processor-based device, for example a digital camera device or mobile phone. The invention also provides for an automatic transfer and classification of the files from the processor-based device to a remote storage, according to the same folder/subfolder hierarchy previously defined on the processor-based device. Furthermore, it reduces the risk of data loss, of classification errors and of deterioration/loss of physical transfer devices as memory cards or cables.

The simplicity and intuitivism of the proposed invention makes it usable by unskilled users from the beginning to the end of the process. In addition, the diversity of the devices on which the method can be executed, and the diversity of different file type it can handle makes it polyvalent. Furthermore, the method helps reducing risk of mistakes and data loss.

According to a possible embodiment of the invention, the proposed invention also allows one to use a mobile processor-based device provided with a camera as a “time clock” (or “punch clock”), by simultaneously taking a picture of a user (with a front camera) and a picture of their environment (with a rear camera), both pictures being associated with a GPS (Global Positioning System) coordinate, a date and a time. With the folder/subfolder creation capacity provided directly on the digital camera device, the user and location pictures are transferred and classified at the proper location on a remote storage system.

Advantageously, this embodiment of the invention allows companies to know the time and location of their employees even when they are outside the company walls. The proposed method improves control over the schedule of travelling employees, and provides means to ensure that a given employee is really the one who completed the work.

### BRIEF DESCRIPTION OF THE DRAWINGS

The present invention and its advantages will be better understood and apparent upon reading the following detailed description made with reference to the accompanying drawings wherein:

FIG. 1A is a schematic diagram illustrating a system for creating and transferring media files, according to a possible embodiment.

FIG. 1B is a schematic presentation illustrating a processor-based device in the system of FIG. 1A, according to a possible embodiment.

FIG. 1C is a schematic representation illustrating remote storage in the system of FIG. 1A, according to an embodiment.

FIG. 1D is a schematic representation illustrating a computing device in the system, of FIG. 1A, according to an embodiment.

FIG. 2 is a flow chart showing the main steps performed for capturing and transmitting media files, according to an embodiment.

FIG. 3 is a flow chart showing the steps performed for capturing, managing and transmitting media files from a processor-based device to a remote system, according to an embodiment.

FIG. 4 is a schematic diagram illustrating a remote storage, according to an embodiment.

FIG. 5 is a graphical user interface on a processor-based device, showing a main menu, corresponding to step 305 of FIG. 3, according to an embodiment.

FIG. 6 is a graphical user interface on a processor-based device, showing the working folder editing, corresponding to step 310 of FIG. 3, according to an embodiment;

FIG. 7 is a graphical user interface on a processor-based device, showing an example of capturing a document (photos) into media files, corresponding to step 320 of FIG. 3, according to an embodiment.

FIG. 8 is a graphical user interface on a processor-based device, showing an optional step of modifying pictures after being captured, corresponding to step 320 of FIG. 3, according to an embodiment.

FIG. 9 is a graphical user interface on a processor-based device, showing an optional step of annotating a picture without the need of additional programs, corresponding to step 320 of FIG. 3, according to an embodiment.

FIG. 10 is a graphical user interface on a processor-based device, showing an optional step of annexing an audio file to a numeric file (image or video), corresponding to step 320 of FIG. 3, according to an embodiment.

FIG. 11 is a graphical user interface on a processor-based device, showing the transferring step, corresponding to step 340 of FIG. 3, according to an embodiment.

FIG.12 is a graphical user interface on a processor-based device, showing the transferring step in progress, corresponding to step 340 of FIG. 3, according to an embodiment.

While the invention will be described in conjunction with an example embodiment, it will be understood that it is not intended to limit the scope of the invention to such embodiment. On the contrary, it is intended to cover all alternatives, modifications and equivalents as may be included as defined by the appended claims.

### DESCRIPTION OF A PREFERRED EMBODIMENT

In the following description, similar features in the drawings have been given similar reference numerals. To preserve the clarity of the drawings, some reference numerals may have been omitted if they were already identified in a preceding figure.

Broadly described, the present invention allows transferring media files, such as audio, images, text, compressed images, jpeg or video files, from processor-based devices to a specific location on a remote storage system without having to first create the specific location at the remote storage system. In other words, the folder/subfolder directory does not need to be created on the remote storage system before starting the transfer process from the processor-based device.

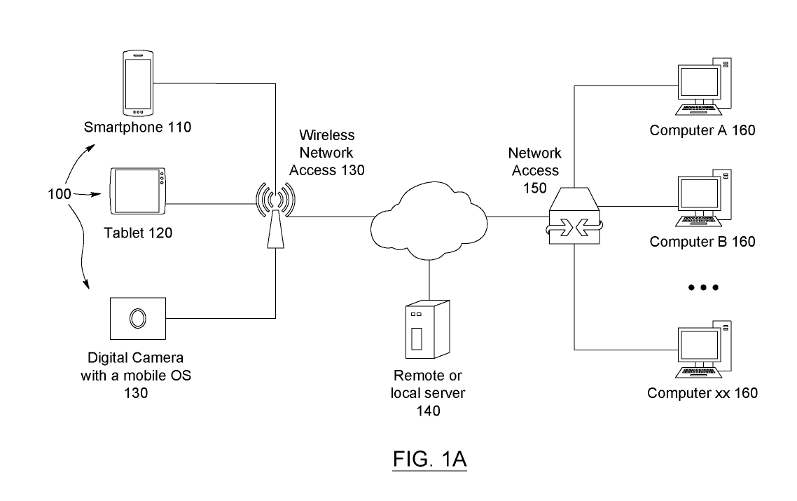

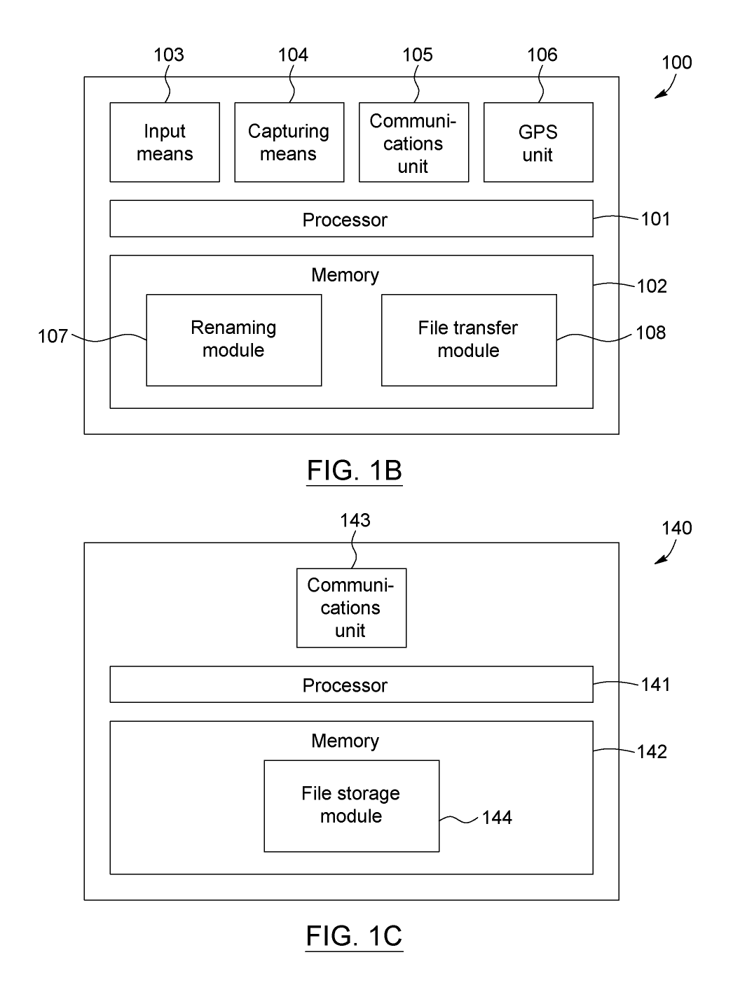

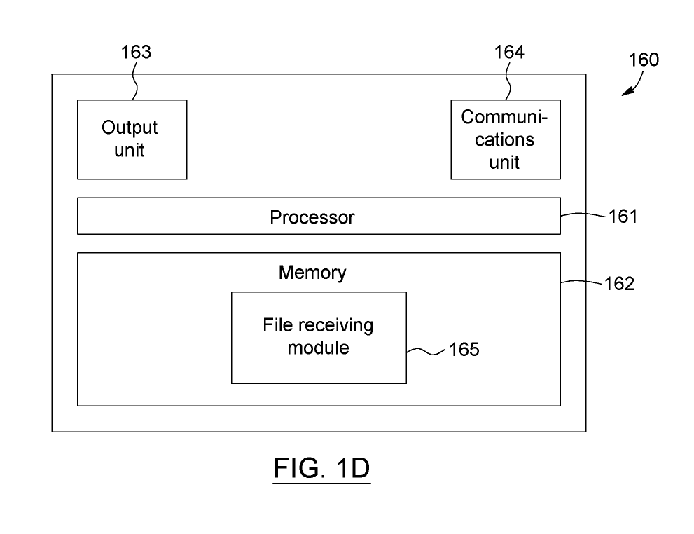

FIG. 1A illustrates a system for creating and transferring media files, according to an embodiment. The system includes at least one processor-based device 100. The processor-based device 100 can be, for example, a wireless mobile device, such as a smartphone 110, a tablet 120, or a digital camera 130 running an operating system (OS) such as iOS, Android, Windows or the like. In other embodiments of the invention, the processor-based device can be a fax, a photocopier or a scanner.

The processor-based devices 100 communicate with remote storage 140, which can be a remote or local server, via a network connection 130. Preferably, the network connection is a wireless network connection, for providing a communication link between the processor-based devices 100 and the remote storage 140. Examples of possible wireless network connections include Wi-Fi, cellular networks, Wi-max, etc. The remote storage 140 is a storage system which can store media files transferred from the processor-based devices 100. The storage system is referred to as “remote” because it stores the files in a location external to the processor-based devices 100, i.e. in a location remote to the processor-based devices 100. The remote storage 140 could be a server, for example, several servers, or any other device or devices capable of communicating with the processor-based devices 100 and storing media files in a directory-based structure. The media files being transferred and stored in the present system may be media files, or any other types of digital files, irrespective of file-type or extension.

The system may also comprise one or several computing devices 160 which communicate with the remote storage 140 via a network connection 150. The computing devices 160 can be general purpose computers, such as a desktop, laptop, or the like. The computing devices 160 are configured to receive files from the remote storage 140 which were transferred from the processor-based devices 100. The network connection 150 can be a wired or wireless connection allowing the computing devices 160 to establish a communication link with the remote storage 140, over a local area network (LAN), wide area network (WAN), intranet or internet, for example.

In more detail, referring to FIG. 1B, the processor-based devices 100 include a processor 101, memory 102, input means 103, capturing means 104, a communications unit 105 and optionally a global positioning system (GPS) unit 106. The processor 101 is an integrated circuit (IC) device capable of executing instructions stored in the memory 102. The memory can be transitory or non-transitory, and may also allow for the storage of media files captured or generated by the processor-based device 100. The input means 103 allow a user to provide input to the processor-based device, and can be a touchscreen, keyboard, mouse, or any other type of peripheral or integrated input device. The input-means 103 allow a user to select and/create a working directory, i.e. a directory in the device's file-structure system where media files should be stored. The working directory could include a series of folders and subfolders. The capturing means 104 allow for the creation of media files. The capturing means could be devices allowing the capturing of information to generate a media file, and may include one or several devices such as a digital camera, microphone, keyboard, digitizer, scanner, and the like. The communications unit 105 allows the processor-based device 100 to communicate with other devices, and can be a communications port allowing the processor-based device 100 to communicate through a wired or wireless connection over a network. The GPS unit 106 is a device capable of receiving data from GPS satellites in order to calculate the geographical location of the processor-based device 100.

The memory 102 of the processor-based device 100 stores instructions in the form of a computer program executable by the processor 101. The memory 102 includes the following modules:
A renaming module 107 for renaming media files for future transmission. The renaming module can include renaming instruction for automatically renaming the media files to include indicia corresponding to the working directory. The indicia can be any type of distinctive markings allowing for the storage and recovery of the working directory information within the filename of the media files. The indicia could be, for example, a string embedded or encoded within the file name, and may also include additional indicia such as the date, time and GPS location. For example, the filename could include a string of character-separated values describing the folder/subfolders of the working directory, and the date and time of file creation. For example a file “Foo.ext” could be renamed as “folder_subfolder_Foo_yyyy-mm-dd_mm-ss.ext”. The information relating to the folder/subfolder, date, time and the original filename of the media file can be subsequently recovered by separating the string along the underscore (“_”) character. In other embodiments, different separating characters could be used. In yet other embodiments, a different encoding scheme could be used altogether. For example, the indicia could be stored in a class, object or struct, and subsequently serialized for use in the filename. The filename may also be encrypted using a two-way encryption algorithm to reversibly hide and/or obfuscate the indicia.
A file transfer module 108 for uploading/transferring media files. The transfer module 108 could include transfer instructions to upload the media files into their respective folders on the remote storage, according to the working directory information provided in the indicia of the filename of each media file. The transfer instructions include instructions to direct the remote storage to create a storage folder local to the remote storage corresponding to the working directory, if said storage folder does not already exist. In this fashion, the media file can be transferred to the remote storage to be stored in a location corresponding to the working directory, even if that location does not already exist on the remote storage when the transfer is initiated.

The memory 102 may also contain the following modules, among others:
A directory management module which includes means to store information related to the working directory or folder, such as the folder/subfolder names and hierarchy.
A communication management module, for establishing a connection between the processor-based device and a remote server via a transmitting protocol. While it is preferable that the communication be a wireless connection, it is possible for that the communication link be cabled connection.
An “extraction” module for extracting the folder/subfolder information from the indicia in the media file filename and for creating the directory hierarchy on the remote server, when the folders are not already created.

Referring now to FIG. 1C, the remote storage 140 can be a server, several servers, or other such devices capable of storing media files in a directory structure. The remote storage 140 includes a processor 141, memory 142 and a communications unit 143. The processor 141 is an IC device capable of executing instructions stored in the memory 142. The memory 142 can be transitory or non-transitory, and allows for the storage of media files received from the processor-based devices 100. The communications unit 143 allows the remote storage 140 to communicate with other devices, such as the processor-based devices 100 and the computing devices 160, and can be a communications port allowing the remote storage 140 to communicate through a wired or wireless connection over a network. The memory 142 includes a storage module 144 containing storage instructions executable by the processor 141 to receive media files from the processor-based devices 100, identify the indicia in the file name of the media file, create a storage folder in the memory corresponding to the indicia and to save the media files to the storage folder. The remote storage 140 can therefore receive files from the processor-based devices 100, save the files and retain information about the working directory in which the files were created. The remote storage 140 may also contain a module to send the media files to the computing devices 160 and include information about where the media files should be stored in order to correspond to the working directory.

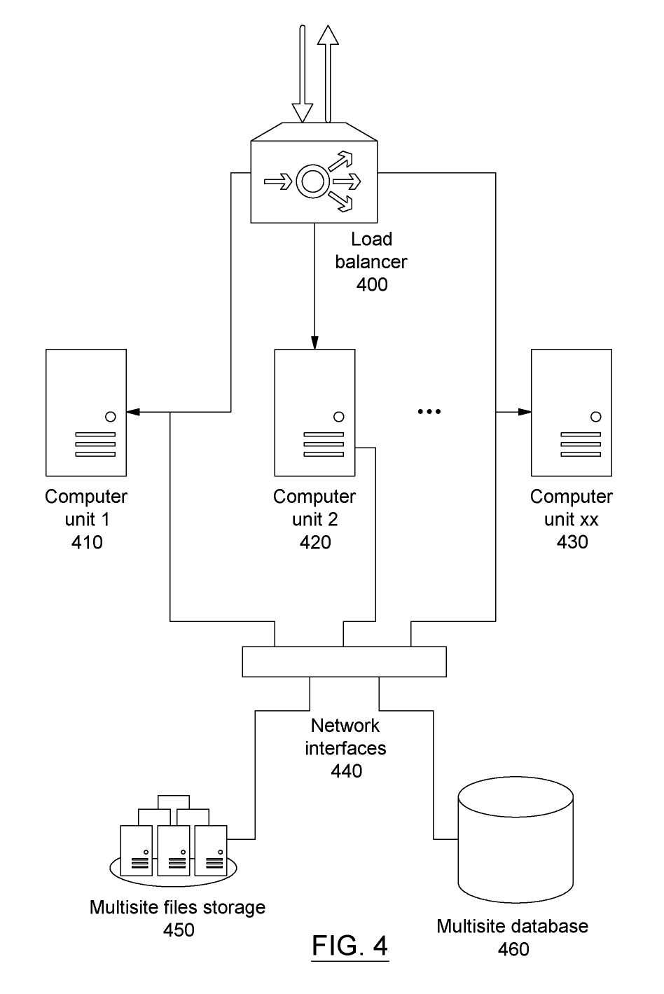

Referring to FIG. 4, a schematic drawing illustrates a possible architecture of a remote or local server 140, to which the files are to be sent and stored. The architecture includes a load balancer 400, for balancing the workload between different computers 410, 420, 430. The different computers 410, 420, 430 are in turn linked to a multisite file storage 450 and/or to a multisite database 460, via a network interface 440.

Referring now to FIG. 1D, a computing device 160 can be a personal computer or a server, and may be local or remote to the remote storage 140. Each computing device includes a processor 161, memory 162, an output unit 163 and a communications unit 164. The processor 161 is an IC device capable of executing instructions stored in the memory 162. The memory 162 can be transitory or non-transitory, and may also allow for the storage of media files received from the remote storage 140 which were originally captured or generated by the processor-based devices 100. The communications unit 164 allows the computing device 160 to communicate with other devices, such as the remote storage 140, and can be a communications port allowing the computing device 160 to communicate through a wired or wireless connection over a network. The output unit 163 is a device which allows the computing device 160 to interact with a human user and provide the human user with feedback. The output unit 163 could generate notifications perceivable by a human user, and could be a screen or speaker, for example.

The memory 162 of the computing device 160 stores instructions in the form of a computer program executable by the processor 161. The memory 162 includes a file receiving module 165 containing receiving instructions executable by the processor 161 to receive media files from the remote storage 140, create a local folder in the memory based on the indicia in the file name of the media file and save the media file to the local folder. The receiving instructions therefore allow a computing device 160 to receive the media files from the remote storage 140 and save them to a local directory which matches the working directory which was originally selected on the processor-based device 100 which created the media file. The memory 162 may also contain a module which has provides the instructions to monitor received files and to generate a user-perceivable notification on the output unit 163 if the receive file matches a predetermined criteria. For example, a user can be notified whenever a new file is received in a specific working directory. The notification can be an alert or popup on the screen of the computing device, for example.

As can be appreciated, the architecture presented allows providing the media file management services to different entities, each entity having its own user computer. For example, the network architecture presented allows to service different auto body mechanics, from different companies. Each auto body shop provides his car evaluators with mobile devices: some will choose smartphones, while others choose sophisticated digital cameras with high resolution lenses. The mobile devices are each provided with an application as described above. Evaluators from different body shops can upload their image/audio files to the same remote storage server: using the same remote storage server facilitates maintenance and management tasks. The files can then be transferred to personal computers or servers owned by the different auto body shops, allowing them to have access to the files locally. Evaluators at the body shops can be notified when files are transferred to them in their assigned working directories.

Of course, while the example describe above applies to auto body shops, the method and system described below can be used in other fields, such as for home evaluators, real estate agents, professional photographers and simple users who need to capture and store large numbers of media files or other types of media files.

According to another aspect of the present invention, the following figures illustrate methods for transferring and storing media files. The methods may use the system as described above. In the illustrated embodiments, the processor-based devices are mobile devices and the media files are typically photos and/or videos. Of course, these can vary according to other possible embodiments. For example, it other embodiments, the media files can be scanned images captured by a photocopier or a scanner.

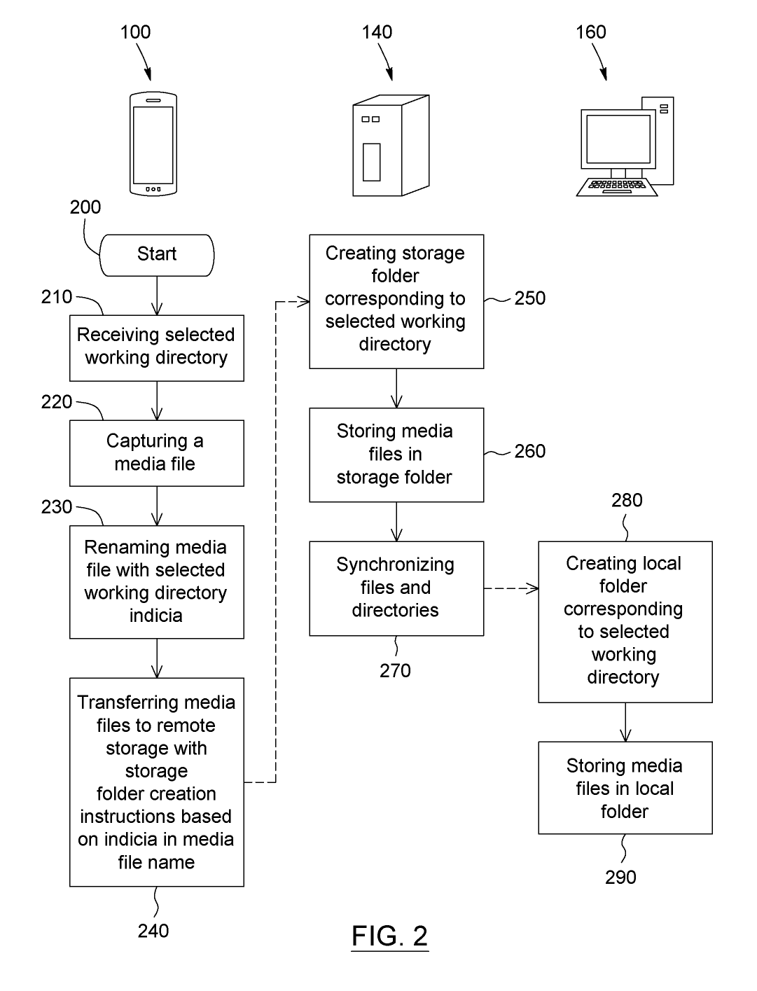

Referring to FIG. 2, a general flow diagram of the steps of the method is shown. The first step 210 consists of receiving a user input corresponding to a selected working directory on the processor-based device 100. A user can select a default directory or create a new directory on the mobile device, prior to capturing images or videos. The mobile device thus receives and stores directory information (i.e. folder and/or subfolder name) on the mobile device. The user input can be a command input from a user through an application running on the wireless mobile device, whereby the user selects a desired working directory. The command input includes a folder or directory name. The application running on the mobile device stores the directory information in its memory. The directory/folder is not necessarily created on the mobile device: it is the directory information (name) that is stored in memory. In other embodiments, it can be considered to create the directory on the mobile device as well.

The next step 220 consists of generating or capturing a media file, such as text, pictures, annotated pictures, audio files, videos, scanned documents and the like.

In step 230, once the file is captured, the application program running on the mobile device renames the media file (i.e. changes the file name) according to the working directory information provided by the user in step 210. Additional information may be added in the file name, such the time, date and location, in order to be able to distinguish individual files in the same folder. The file name thus includes indicia corresponding to the selected working directory and may include additional indicia with additional information. As mentioned above, the indicia can be any type of distinctive marking allowing for the storage and recovery of information within the filename of the media files. In the present embodiment, a character-separated string is used for storing the working directory, date, time and location in the filename of the media file. Of course, in other embodiments, other techniques are also possible.

Step 240 consists of transferring the media files from the mobile device to the remote storage system 140, which can consist of, for example, a server. This step requires to have established a communication link with the remote server. Once a communication link exists between the mobile device and the remote server, the transferring step includes the creation of a folder on the remote server by the mobile device. As can be appreciated, it is the mobile device that controls the creation and management of the directories on the remote server. The transferring step can begin even if the directory folders have not been previously created at the remote server location. The media files of the mobile device are transferred in the respective folders on the remote servers, which are created when not already existing.

In an embodiment, the mobile device provides instructions to the storage system in order to create the directory or directory structure corresponding to the working directory, simultaneously during the transfer of the media files. The media file itself comprises these instructions—the desired directory structure is embedded within the file name of the media file. In step 250, upon receiving the media file, the remote storage creates the directory structure and, in step 260, stores the media file in the appropriate place, based on information found in the file name. In this fashion, the media file can be uploaded to the storage server without having to create the desired working directory beforehand. Additionally, no additional information needs to be communicated, other than the file, avoiding the possibility of data corruption.

On the remote storage side, an optional step 270 consists of synchronizing the files and folders of the remote servers 140 to computing devices 160, such as client computers, which are located remotely from the remote storage 140. File synchronization between the remote storage 140 and the local computing device 160 triggers the creating of local folder(s) on the computing device, at step 280, and storing the media files in the local folder(s). Again here, the file name can include the instructions to create the local folder(s) when not already existing.

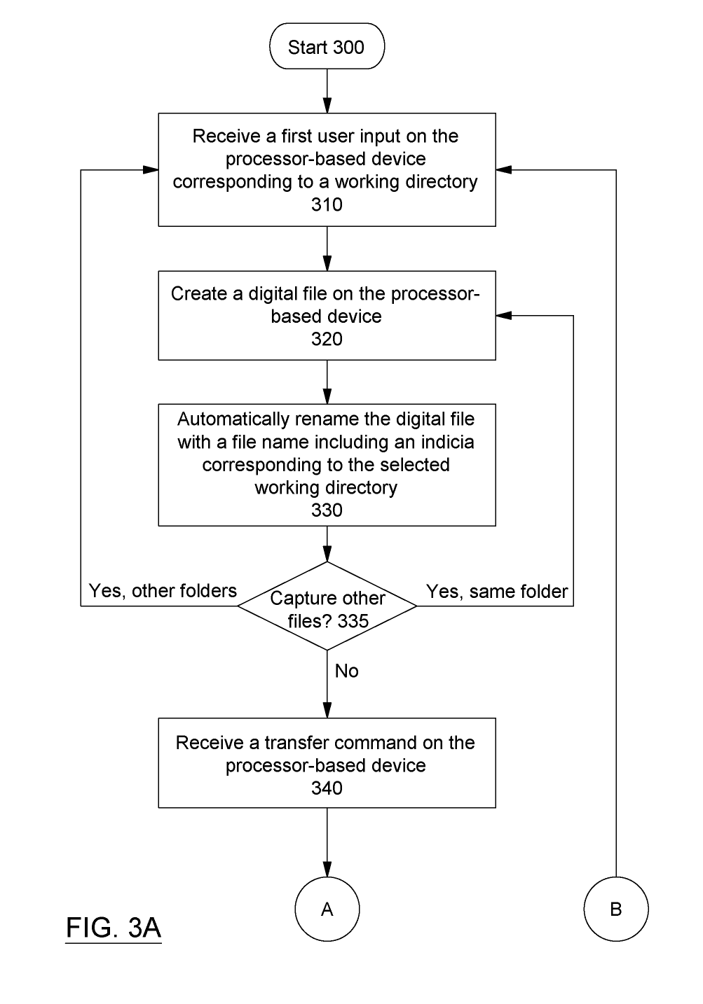

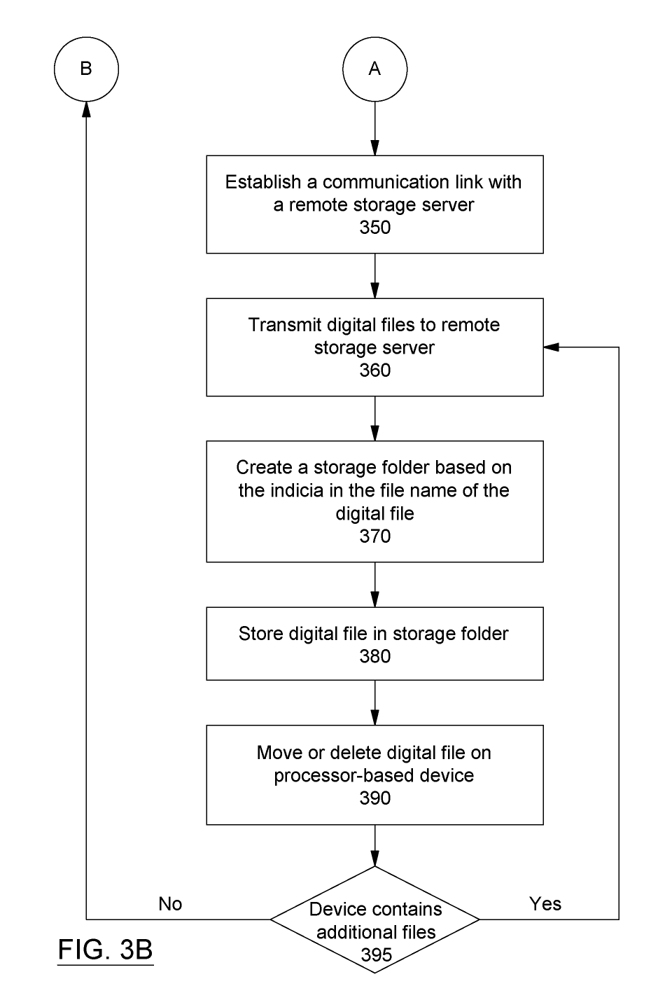

Referring to FIG. 3, a more detailed flow diagram is shown, in which the steps 210 to 290 are described in more detail, according to a possible embodiment of the invention.

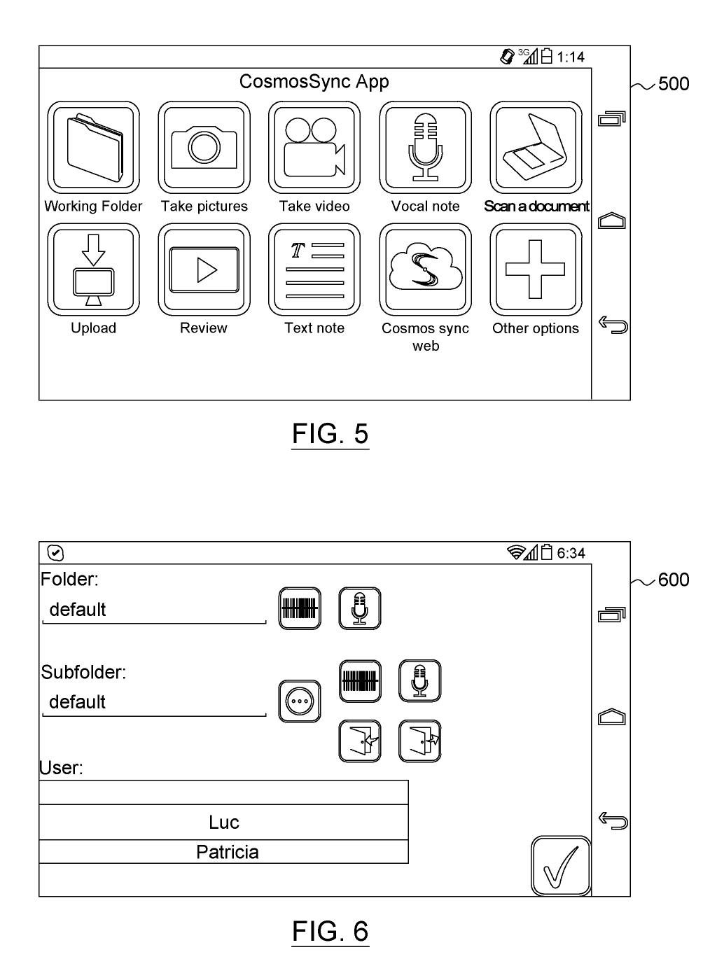

The method 300 starts with step 310, during which the mobile device receives a first input from input means, such as the tactile display screen, to select a capturing mode. FIG. 5 provides an example of a graphical user interface 500 allowing a user to select between different capturing modes, such as image, video or audio mode. The mobile device includes a camera to capture images and/or videos, a microphone to capture sound, a memory and a processor running an operating system such as Android, iOS, Windows, or any other operating system. The device also receives an input from input means, such as the keyboard of the tactile display screen (or any other input component accessible from the device) to set up the working folders/directories. For example, a user selects the option “Working folder” to select an existing directory name or to create a new directory, by typing the folder and/or subfolder name. The folder name can also be derived from a bar code, or captured in an audio file recorded on the mobile device. FIG. 6 is a graphical user interface 600 corresponding to this step.

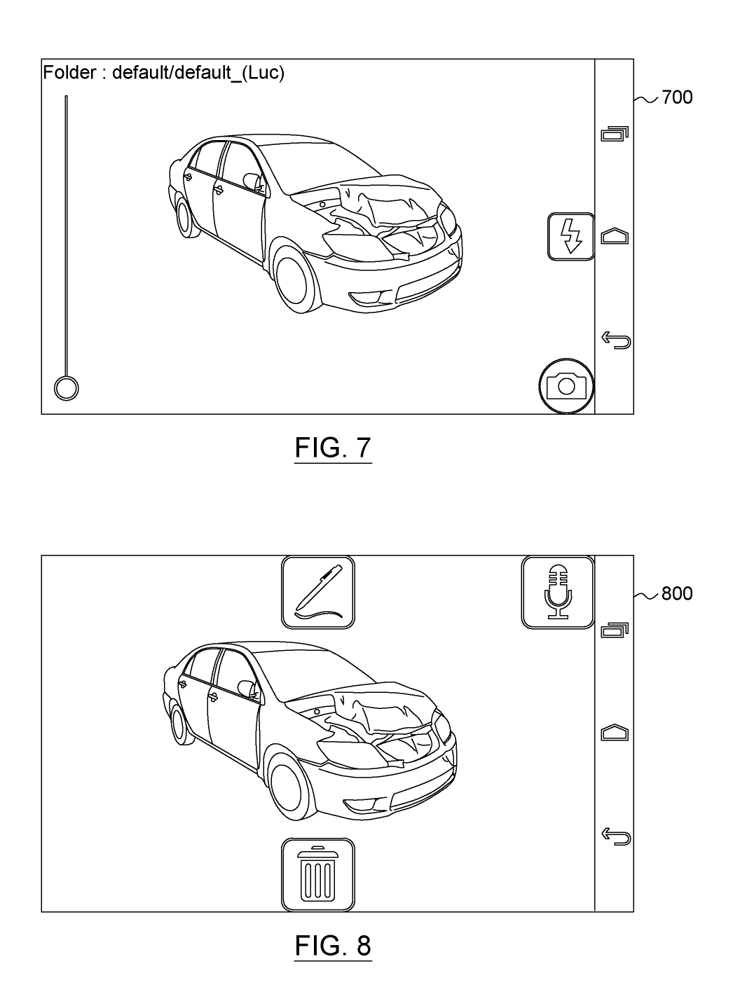

In step 320, the device receives an input from the input means (such as from the tactile display screen) to capture documents in a numeric/digital file format. Different types of documents can be captured, such as images, videos, audio files or any other document which is supported by the application. The graphical user interface 700 shown in FIG. 7 provides an example of step 320.

In some embodiments, the method can be used as a virtual punch-card. For example, an image from a front and rear camera can be taken simultaneously, along with GPS data and date/time data. The front camera could take a picture of the user while the read camera takes a picture of their environment, both being associated with a GPS coordinate, a date and a time.

In step 330, the mobile device stores the media file captured in step 320 and renames it to include indicia corresponding to the directory information stored in step 310. The indicia could include, for example, a string including each folder in the directory structure of the working directory. Each folder in the string could be separated by slashes so that each folder name can be separated and the directory structure recovered. For example, the file name can be “mainfolder folder subfolder prefix_yyyy_mm-dd-hh.mm.ss.ext”, the indicia being the portion “mainfolder folder subfolder” in the file name. It will be appreciated that the directory information is saved directly in the file name, and not in a header of the file, which makes it readily accessible for the transferring step. Step 330 is performed as a background task, such that this step is transparent for the user.

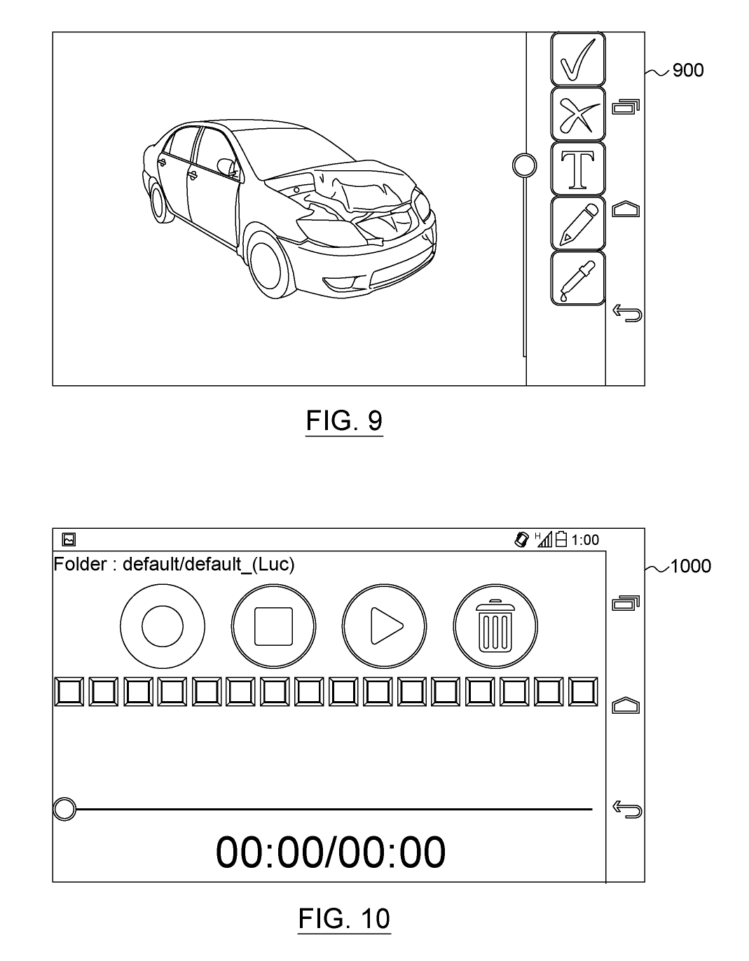

In step 335, the mobile device receives additional inputs from input means to capture additional images or media files. For example, a user can decide to comment an image by annexing audio comments to the image, via a graphical user interface 1000, such as shown in FIG. 10. It is also possible to annotate an image by adding drawings, via a graphical user interface 800 such as shown in FIG. 8. Text can also be added in the captured image, via a graphical user interface 900 such as shown in FIG. 9.

It is common to capture an object from many different angles, such as for a damaged car, in the case of auto body mechanics, and therefore a plurality of images can be captured and linked to the same directory. Consequently, steps 320 and 330 are repeated until a user has captured the desired number of files. All documents (i.e. images and annotated or commented images) are linked to the same working directory selected or created in step 310. The user may also capture files to be linked to a different working directory. In such a case, steps 305, 320 and 330 are repeated.

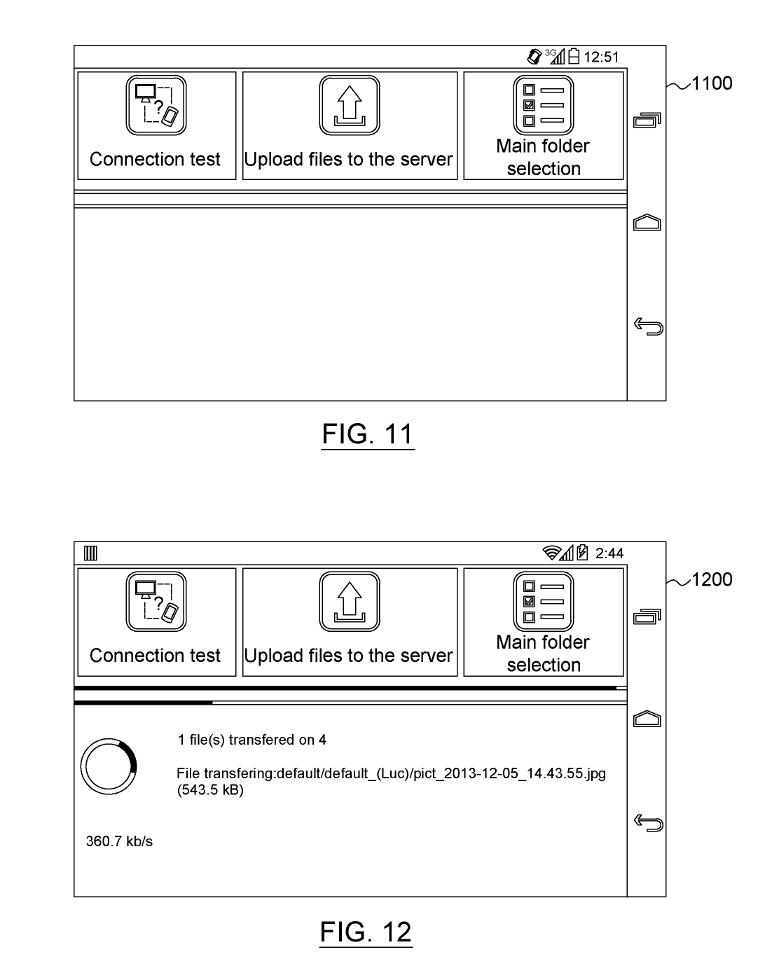

When all documents have been captured, the mobile device receives a transfer command. Responsive to the transfer command, the transfer module transfers the files from the device memory to a predetermined remote storage location. The transfer command can be a user input, for example, such as by touching a button on a touchscreen. FIGS. 11 and 12 show graphical user interfaces 1100 and 1200 allowing a user to access and monitor the transfer step. In other embodiments, the transfer command can be initiated by a background process and thus automatic and transparent to the user. For example, the background process could initiate the transfer command when a network connection is available. The user can also provide an input to set a persistent setting to enable or disable this functionality by the background process, according to their desired preference.

The following steps 350 to 395 include operations performed as background tasks, which are transparent to the user.

In step 350, the mobile device establishes a connection to a remote storage, which can be a predetermined local or remote server. The access information to the local or remote server has been previously stored in the memory of the mobile device.

In step 360, the structure of the filename of each image stored within the memory of the mobile device is read and split into multiple portions, for example by using an array of strings, each portion corresponding to a directory location (ie folders) and to the final name under which the file will be saved at the remote server. For example, the file name can become “mainfolder/folder/subfolder/prefix_yyyy-mm-dd_hh.mm.ss.ext”.

In step 370, the mobile device requests the remote server for a list of existing folders and compares it with the folders determined in step 360. If folders determined in step 360 are not present in the list received from the remote server, the mobile devices sends the remote server a command signal to create the missing folders on the remote server. Preferably, step 370 includes a sub-step of verifying whether a file having the same file name as the one to be transferred already exists on the remote server. If it is the case, then the file present of the server is deleted to avoid data corruption or duplicate files. In other embodiments, the mobile device need not request any information from the remote storage, and can instead transmit the files with the desired storage location embedded within the filename of the transmitted file. The remote storage could independently create the required storage locations upon receiving the files.

In step 380, the mobile device transfers each of the files associated to the same directory location to the server, and stores them in the proper directory. In step 390, the mobile device can optionally receive a confirmation message from the server that confirms the file transfer. Upon receiving the server confirmation, the file can optionally be deleted from the memory of the digital camera, or alternatively be transferred to another location in one of the non-transitory memories of the mobile device instep 390.

As indicated by step 395, the mobile device will repeat step 360, 370, 380 and 390 until there are no other files to upload. Of course, it can be considered to execute steps 360 and 370 only once, for all files, and then upload all files during the same step 380.

Once the transfer is completed, it is possible to end the process or start a new one as per step 305.

In some embodiments, several media files can be transferred simultaneously. For example, the steps 360 to 390 could be done in parallel for each of the files being transferred. Additionally, in step 350, separate communication links could be established for each simultaneously transferred media file. For example, one or several media files could be transferred over WiFi, while one or several others could be simultaneously transferred over a cellular data network such as 3G.

Referring to FIG. 6, a graphical user interface 600 is shown, for providing access to the working folder editing step. Different media can be used in order to enter the folders name. It is possible to select a directory location (or “folder/subfolder” location) via a predefined selection, by typing the folder name, by scanning a 2D barcode, by capturing a voice command, and the likes. Once the directory location is received, the information is stored in the device memory.

Referring to FIG. 7, a graphical user interface is provided for allowing a user to capture a numeric file, in this case a picture. FIG. 8 is the graphical user interface allowing a user to view the image captured.

FIG. 9 shows a graphical user interface allowing a user to modify the image captured, for example to add text, drawings, voice comments, etc. FIG. 10 is a possible graphical user interface allowing a user to record voice data as an audio file.

FIG. 11 shows a graphical user interface allowing a user to transfer files from the mobile device to the remote storage system. Devices to check the availability of the connections and to select all at once the desired files to be sent are launched via this interface.

FIG. 12 shows a graphical user interface displaying the status of the file transfer.

While steps 360, 370 and 380 described above are initiated by the mobile device, it is possible that in other embodiment, these steps are initiated and/or executed from the remote storage location. In other words, the processing steps can be performed on either one of the mobile devices or the server.

In alternate embodiments, it is possible to create the working folders into the device memory and to store the files on the mobile device's memory. In this alternate embodiment, the folders provided on the mobile device are a reflection of the folders on the server. For the transmission step, a recursive function is performed to scan all the folders individually.

Another alternative is to create, for each file, an entry into a local database which contains all the information about the files and workings folders. When transmitting the files, the mobile device or the server verify entries from the database to ensure that the files are properly stored from the mobile device memory to the server memory.

In other embodiments, the method can be carried out on a processor-based device such as a photocopier or scanner. The photocopier or scanner could be stand-alone OS-based devices, or could be attached as a peripheral to an OS-based device, such as a desktop computer or laptop. In both cases, the UI could be provided on the photocopier or scanner, allowing a user to select the working directory directly on the photocopier or scanner in order to commence the process starting from step 310. The remaining steps of the method could then be carried out as normal.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A method for creating and transferring media files, the method comprising the steps of:
a) receiving, on a processor-based device, a first user input corresponding to a selected working directory;
b) capturing at least one media file with the processor-based device;
c) pre-classifying, on the processor-based device, the at least one media file by automatically renaming the at least one media file with a file name including indicia corresponding to the selected working directory;
d) receiving a transfer command on the processor-based device; and
e) responsive to said transfer command, establishing a communication link between the processor-based device and the remote storage, and transferring the at least one media file to the remote storage so as to store the at least one media file on the remote storage according to the pre-classification on the processor-based device, and generating instructions directing the remote storage to create a storage folder based on the indicia in the file name of the at least one media file, and to store the at least one media file in the storage folder;
wherein steps a), b), c) and d) are performed prior to establishing the communication link between the processor-based device and the remote storage.

2. The method according to claim 1, comprising a step performed prior to step a), of selecting a pre-existing default directory or creating a new directory on the processor-based device, the selected working directory in step a) comprising one of the pre-existing default and the new directory.

3. The method according to claim 1, wherein in step b), said at least one media file captured with the processor-based device comprises at least one of a picture file, a video file, an audio file and a text file.

4. The method according to claim 1, wherein in step b), said at least one media file captured with the processor-based device comprises several picture files and at least one of an audio file and a text file.

5. The method according to claim 1, wherein step b) comprises simultaneously capturing a first image and a second image, the first image being a user image captured with a front camera of the processor-based device, and the second image being a location image captured with a rear camera of the processor-based device, and combining the first and second images into a single image file.

6. The method according to claim 5, wherein step b) further comprises simultaneously capturing global positioning system (GPS) coordinates along with the first and second image, and embedding the GPS coordinates into the single image file.

7. The method according to claim 6, wherein in step b), embedding the GPS coordinates into the single image file comprises adding a visual representation of the GPS coordinates in pixels of the single image file.

8. The method according to claim 1, wherein step c) further comprises automatically renaming the at least one media file with the file name including additional indicia corresponding to one of a creation date, a creation time and a location.

9. The method according to claim 8, wherein step b) further comprises capturing global positioning system (GPS) coordinates of the processor-based device and wherein in step c) the location includes the GPS coordinates.

10. The method according to claim 1, wherein step c) further comprises pre-classifying, on the processor-based device, at least one other digital file associated with the at least one media file, by automatically renaming the at least one other digital file with a file name including indicia corresponding to the selected working directory.

11. The method according to claim 10, wherein step e) further comprises transferring the at least one other digital file to the remote storage for storing the at least one other digital file on the remote storage according to the pre-classification on the processor-based device.

12. The method according to claim 1, wherein in step d), receiving the transfer command comprises receiving a second user input on the processor-based device.

13. The method according to claim 1, wherein in step d), the transfer command is sent by a background process running on the processor-based device.

14. The method according to claim 1, wherein step e) further comprises receiving on the processor-based device a confirmation, from the remote storage, that the at least one media file was successfully transferred to the storage folder.

15. The method according to claim 1, wherein step b) further comprises storing the at least one media file on the processor-based device in a location corresponding to the selected working directory.

16. The method according to claim 15, further comprising a step of moving or deleting the at least one media file from the location corresponding to the selected working directory on the processor-based device.

17. The method according to claim 1 wherein the at least one media file is a plurality of media files and step e) comprises transferring the plurality of media files simultaneously to the remote storage.

18. The method according to claim 1, wherein in step e), establishing the communication link with the remote storage is performed automatically when a network connection is available on the processor-based device.

19. The method according to claim 1, wherein step e) further comprises sending deletion instruction to the remote storage, the deletion instructions directing the remote storage to delete a duplicate of the at least one media file if the at least one media file already exists on the remote storage in the storage folder.

20. The method according to claim 1, further comprising steps of:
establishing a communication link between the remote storage and a computing device;
receiving the at least one media file on the computing device from the remote storage and, in response thereto, creating a local folder on the computing device based on the indicia in the file name of the at least one media file; and
storing the at least one media file on the computing device in the local folder.

21. The method according to claim 20, further comprising the step of synchronizing the local folder of the computing device with the storage folder of the remote storage.

22. The method according to claim 20, further comprising a step of generating a notification on the computing device when the at least one media file received on the computing device has an attribute matching a predetermined criterion, the notification being a user-perceivable notification.

23. The method according to claim 22, wherein the user-perceivable notification is an alert requiring a user interaction in order to dismiss the notification.

24. A system for creating and transferring media files comprising: at least one processor-based device comprising:
a memory and a processor;
a communication unit configured to establish a communication link with a remote storage;
input means for receiving a first user input corresponding to a selected working directory;
capturing means for capturing at least one media file;
a renaming module stored in the memory and comprising renaming instructions executable by the processor to pre-classify the at least one media file on the processor-based device before establishing the communication link with the remote storage, by automatically renaming the at least one media file with a file name including indicia corresponding to the selected working directory; and
a file transfer module stored in the memory and comprising transfer instructions executable by the processor to transfer the at least one media file to the remote storage, said transfer instructions directing the processor-based device to establish the communication link with the remote storage and transfer the at least one media file to the remote storage, and directing the remote storage to create a storage folder based on the indicia in the file name of the at least one media file, and to store the at least one media file in the storage folder.

25. The system according to claim 24, wherein said at least one processor-based device comprises one of an OS-based digital camera, a smart phone, a tablet and a laptop.

26. The system according to claim 24, further comprising at least one computing device comprising:
a memory and a processor;
a communications unit configured to establish a communication link with the remote storage; and
a file receiving module stored in the memory and comprising receiving instructions executable by the processor to receive the at least one media file from the remote storage, create a local folder on the memory based on the indicia in the file name of the media file and save the media file to the local folder.

27. The system according to claim 26, wherein the at least one computing device comprises one of a server, a desktop computer and a laptop computer.

28. The system according to claim 24, wherein the remote storage comprises:
a memory and a processor;
a communications unit configured to establish a communication link with the processor-based device; and
a file storage module stored in the memory and comprising storage instructions executable by the processor to receive the at least one media file, identify the indicia in the file name of the at least one media file, create the storage folder in the memory corresponding to the indicia, and save the at least one media file to the storage folder.

29. A computer program product for creating and transferring media files comprising:
a computer usable medium including computer usable program code for creating and transferring media files, the computer program product including:
computer usable program code for receiving, prior to establishing a communication link with a remote storage, a user input corresponding to a selected working directory;
computer usable program code for capturing at least one media file and pre-classifying the at least one media file locally by renaming the media file to include indicia corresponding to the selected working directory;
computer usable program code for receiving a transfer command; and
computer usable program code for establishing the communication link with the remote storage and transferring the media file to the remote storage, the media file comprising storage instructions directing the remote storage to create a storage folder based on the indicia in the file name of the media file, and to store the media file in the storage folder.
